(19) United States
(12) Patent Application Publication
(10) Pub. No.: US 2004/0003799 A1
(43) Pub. Date: Jan. 8, 2004

(54) Carburetor heater for ATV

(75) Inventors: Eric Bouffard, Notre-Dame du Mont Carmel (CA); Jean-Marc Fortier, Valcourt (CA)

Correspondence Address: PILLSBURY WINTHROP, LLP, P.O. BOX 10500, MCLEAN, VA, 22102, US

(73) Assignee: Bombardier Inc., St-Bruno (CA)

(21) Appl. No.: 10/612,047

(22) Filed: Jul. 3, 2003

Related U.S. Application Data
(60) Provisional application No. 60/393,095, filed on Jul. 3, 2002.

(51) Int. Cl. F02G 5/00

(52) U.S. Cl. 123/543

(57) ABSTRACT

A carburetor heater is provided to improve the operation of a carburetor, especially in cold and/or humid conditions, by minimizing moisture freezing therein. The carburetor heater is designed to accommodate a heating element within a conductive body that is shaped to complement the outer surface of the carburetor. The heater is fastened to the carburetor and attached to other elements of the engine or vehicle so as to be isolated from engine vibrations. The heating element can be a passage coupled to a cooling system of an all-terrain vehicle, and/or a resistive element coupled to an electrical system of the all-terrain vehicle, which is representative of the variety of vehicles with which the carburetor heater may be used.

The present application claims priority to U.S. Provisional Application Serial No. 60/393,095, which was filed on Jul. 3, 2002, the entirety of which is hereby incorporated into the present application by reference.

### BACKGROUND OF THE INVENTION

1. Field of the Invention

The present invention relates to a carburetor, especially a carburetor for use with an all-terrain vehicle (ATV).

2. Description of Related Art

An all-terrain vehicle (ATV), as is commonly known, can be operated in various conditions, including cold and humid conditions. ATVs are especially noted for their use in off-road type conditions, which can include moist woodland environments, for example. ATVs are typically powered by internal combustion engines, which may include a carburetor. Carburetors are susceptible to poor performance in cold, damp environments to which ATVs are commonly exposed. The reason for this is that during operation, air from the environment is drawn into the carburetor and mixed to form an air-fuel charge. Latent heat of evaporation of the fuel mixed with the air in the carburetor, in addition to the negative pressure of the venturi, can cause moisture in the intake air to freeze, even if the ambient temperature is above freezing.

An example of a typical carburetor in the prior art is illustrated in FIG. 12. The carburetor 1000 is formed by a carburetor body 1002. The carburetor body 1002 has an intake duct 1004 and a mixing chamber 1005 with a vertical portion 1006. The intake duct 1004 is configured to receive air from the environment, typically via an intake port connecting the intake duct 1004 to an airbox and an air filter (not shown). Fuel 1010 within the body 1002 is drawn into the mixing chamber 1005 through an inlet 1007. The air-fuel mixture exits the carburetor 1000 through the outlet 1012. Mixing of air and fuel occurs in the mixing chamber 1005, in particular the vertical portion 1006, which receives a valve piston 1008. Generally, the intake duct 1004 and the vertical portion 1006 have cylindrical cross-sections.

FIG. 12 shows the valve piston 1008 slidably mounted within the vertical portion 1006 of the carburetor body 1002. During normal operation, the valve piston 1008 is typically moved up and down along the axis of the vertical portion 1006 of the carburetor body 1002. The valve piston 1008 can be moved between an open position and a closed position by a throttle control mechanism (not shown) operated by a user. The varying position of the valve piston 1008 allows corresponding amounts of air from the atmosphere to enter through the intake duct 1004 and mix with varying amounts of fuel from the fuel system. For example, during idle or low throttle operation of the engine, the valve piston 1008 would be moved to occupy a majority of the intake duct 1004, blocking a portion of air from the atmosphere entering the intake duct 1004 of the carburetor 1000. In contrast, during full throttle operation of the engine, the valve piston 1008 is moved to vacate the intake duct 1004 and allow an increased amount of air from the atmosphere to enter the intake duct 1004 of the carburetor 1000.

The various components of the carburetor 1000 are constructed within strict tolerances, allowing precise throttle control. When an ATV that includes the prior art carburetor 1000 illustrated in FIG. 12 is operated in cold and/or humid conditions, freezing of moisture in the air entering the carburetor 1000 can interfere with operation of the carburetor 1000. For example, the carburetor 1000 can cause the engine to exhibit poor idling and acceleration performance, or even can cause the engine to stall. In addition to poor idling, poor acceleration performance and stalling, the known carburetor 1000 can malfunction or become inoperable due to freezing moisture. For example, moisture that freezes within the intake duct 1004, the vertical portion 1006 and/or on the valve piston 1008 can prevent the valve piston 1008 from moving up and down within the vertical portion 1006 of the carburetor body 1002. In particular, freezing moisture can prevent the valve piston 1008 from returning to a closed position after being operated at partial or full throttle (partial or maximum open position of the valve piston 1008) for a period of time in a cold and/or humid environment. In such a situation, the user may find it difficult, or even impossible, to return the throttle to the closed position. This means that the engine may operate at partial or full throttle despite the user's intention to stop the engine.

One solution to the problem of moisture freezing in the carburetor 1000 is to supply a source of heat to the carburetor 1000. One method of providing heat to a carburetor is described in U.S. patent application Publication No. US 2001/0020468 A1. The heat is provided through a carburetor mounting plate. The mounting plate includes coolant passages to allow coolant, heated by the engine, to pass through the mounting plate via coupling fixtures. Heat is transferred from the engine to the mounting plate. The mounting plate is positioned between the carburetor and the intake manifold. The carburetor is mounted directly to the mounting plate, allowing heat to transfer from the mounting plate to the carburetor, warming up the carburetor and decreasing the likelihood that moisture will freeze within the carburetor.

However, the use of a mounting plate introduces challenges in the design of the engine. Specifically, the prior art carburetor mounting plate transmits vibrations directly from the engine and frame to the carburetor. This is due to the fact that the mounting plate is directly attached between the carburetor and the frame and/or engine of the vehicle. Such a configuration allows engine and frame vibrations to pass directly through the rigid mounting plate to the carburetor. Vibration of the carburetor may cause the fuel-air ratio to be either too lean or too rich, adversely affecting performance of the engine. Further, the mounting plate is relatively large, heavy, and complicated to manufacture and install. The relatively large mounting plate, therefore, adds to the weight of the engine and the weight of the overall vehicle, degrading vehicle performance. Degraded performance is particularly problematic for an ATV designed with high-performance in mind.

Additionally, heat from the coolant passages of the prior art carburetor mounting plate is distributed over a relatively large area of the mounting plate and applied to one surface of the carburetor. The heat is generally spread out over the mounting surface of the carburetor and cannot be applied to the specific portions of the carburetor that need the heat the most. Accordingly, a large portion of heat transferred from the coolant to the mounting plate is dissipated to the atmosphere and non-essential portions of the carburetor without performing any benefit, i.e., without preventing freezing of moisture in the carburetor.

Another solution to the problem of moisture freezing in the carburetor can be found in U.S. Pat. No. 5,854,464. As discussed in that patent, heat is transferred from a heating medium (engine coolant or engine exhaust) to the carburetor via a heater housing mounted to the carburetor. Alternatively, the heater housing can include an electrical heating element. The heater housing is retrofit to the carburetor by replacing a part of the carburetor with the heater housing. Accordingly, the heater housing forms part of the fuel passage.

Like the mounting plate, use of a heater housing introduces challenges to the design of a carburetor. In particular, replacing a portion of the carburetor with the heater housing can be a complicated procedure, requiring partial disassembly of the carburetor. Moreover, the heater housing must be particularly adapted to suitably interact with the inner workings of the carburetor. Therefore, one design for a heater housing will not be well suited to a variety of carburetors. In addition, the housing applies heat to only a particular portion of the carburetor with which it interacts and can adversely affect the operation of the carburetor if not manufactured and installed with the same degree of precision as the carburetor.

An example of another type of engine heater is disclosed in U.S. Pat. No. 4,351,284. A water heated plenum is associated with the intake manifold of an engine, which is adjacent to the carburetor, and provides heat to the engine manifold prior to heat up of the engine. Coolant flows freely through the plenum when cold, which heats up the manifold. When the engine has warmed up, the flow of coolant is stopped.

In view of the deficiencies of the prior art methods of heating engines, and particularly a carburetor, there is a need for a simple, lightweight carburetor heater that can apply heat to specific areas of the carburetor and not transmit vibrations to the carburetor.

### SUMMARY OF THE INVENTION

An aspect of embodiments of this invention provides a heater that can be easily attached to a carburetor.

Another aspect of embodiments of this invention provides a heater that utilizes latent heat from the engine cooling system to efficiently heat a carburetor.

An additional aspect of embodiments of this invention provides a heater that is independently mounted and does not transmit engine vibrations to the carburetor.

These and other aspects of this invention can be realized by embodiments of the invention. According to one preferred embodiment, an all-terrain vehicle is provided that comprises a frame, a plurality of wheels rotatably mounted to the frame, and an engine assembly mounted to the frame. The engine assembly includes a fuel system having a carburetor formed by a housing with a mixing chamber and an exterior surface, a fuel inlet and an air intake, and a carburetor heater for use with the carburetor. The carburetor heater comprises a main body with a heating element and a fastener that secures the carburetor heater to the exterior surface of the carburetor. The main body has at least a first shaped surface that complements and mates with a portion of the exterior surface of the carburetor.

The invention is also directed to a carburetor heater for use with a carburetor. The carburetor heater comprises a main body with a heating element and a shaped mounting surface, and a fastener mounted to the main body for attaching the main body to a carburetor so that the mounting surface mates with a surface of the carburetor.

The invention is additionally directed to an internal combustion engine assembly that comprises a fuel system, a carburetor formed by a housing with a mixing chamber and an exterior surface, a fuel inlet and an air intake, and a carburetor heater for use with the carburetor. The carburetor heater comprises a main body with a heating element and a fastener that secures the carburetor heater to the exterior surface of the carburetor. The main body has at least a first shaped surface that complements and mates with a portion of the exterior surface of the carburetor.

These and other aspects of the invention will become apparent from the following detailed description taken in conjunction with the drawings, which disclose preferred embodiments of the invention.

### BRIEF DESCRIPTION OF THE DRAWINGS

Referring now to the drawings:

FIG. 1 is a perspective view of an all-terrain vehicle according to one preferred embodiment of the invention;

FIG. 2 is an exploded view of a portion of an engine assembly according to an embodiment of the present invention including an engine, a cooling system, a carburetor and a carburetor heater;

FIG. 3 is an enlarged, perspective, top view of the carburetor heater of FIG. 2;

FIG. 4 is a bottom view of the carburetor heater of FIG. 3;

FIG. 5 is a bottom perspective view of the carburetor heater of FIG. 3;

FIG. 6 is a perspective side view of the carburetor heater of FIG. 3;

FIG. 7 is an enlarged perspective side view of the carburetor heater of FIG. 2 mounted to a carburetor;

FIG. 8 is an enlarged view of the other side of the carburetor heater and the carburetor of FIG. 7;

FIG. 9 is an enlarged rear view of the carburetor heater and the carburetor of FIG. 7;

FIG. 10 is a side view of the carburetor heater and the carburetor of FIG. 7 mounted in a typical vehicle;

FIG. 11 is a schematic bottom view of another embodiment of the carburetor heater in accordance with the invention;

FIG. 12 is a schematic perspective view of a prior art carburetor;

FIG. 13A is a diagram illustrating a flow path of the cooling system of the engine assembly according to an embodiment of the invention;

FIG. 13B is a diagram illustrating a flow path of the cooling system of the engine assembly according to another embodiment of the invention; and

FIG. 14 is an exploded view of a portion of an engine assembly according to another embodiment of the present invention including an engine, a cooling system, a carburetor and a carburetor heater.

### DETAILED DESCRIPTION OF PREFERRED EMBODIMENTS

While this invention is described in connection with an ATV, the carburetor heater of this invention may be used with any internal combustion engine. Moreover, although an ATV has been used for purposes of illustration, this invention is particularly applicable to any type of vehicle, especially those used in cold damp environments, which could include motorcycles, watercraft with marine engines, boats and snowmobiles.

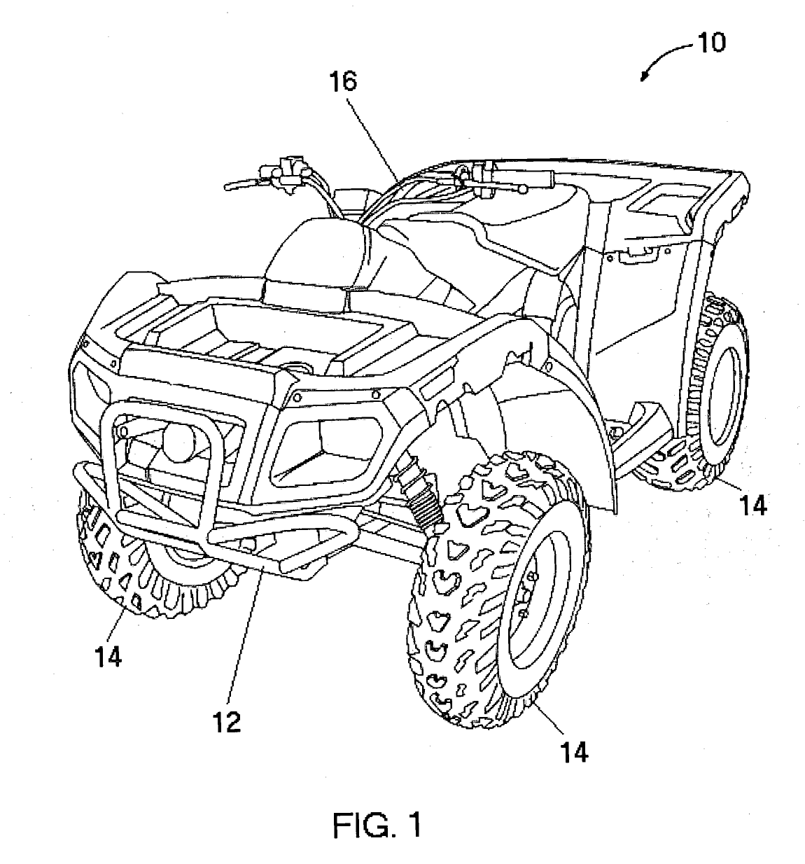

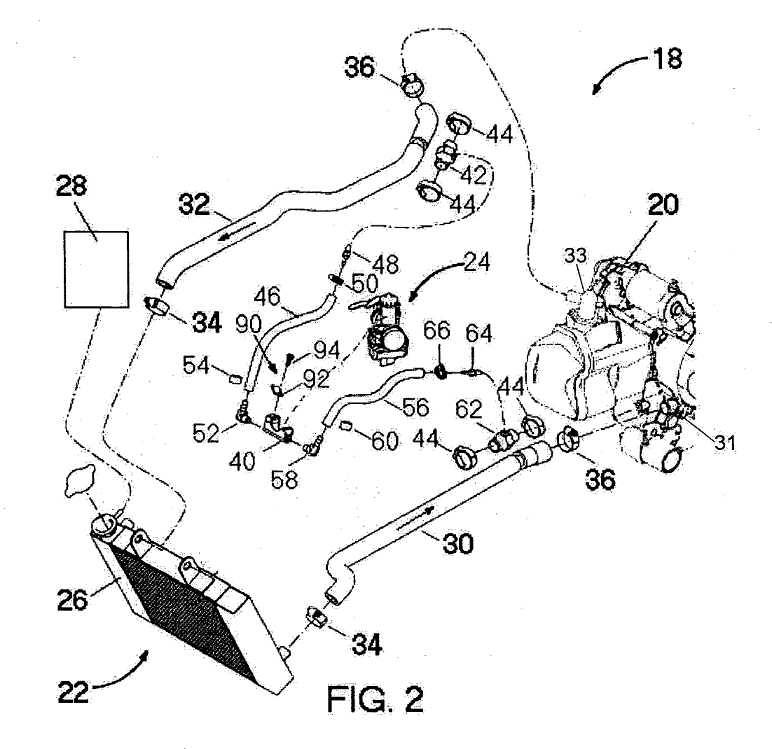

An all-terrain vehicle (ATV) 10 is illustrated in FIG. 1. The ATV 10 generally includes a frame 12, a plurality of wheels 14 rotatably connected to the frame 12, and a steering mechanism 16 configured to directionally control at least one wheel 14. As seen in FIG. 2, the vehicle 10 has an engine assembly 18 with an internal combustion engine 20 configured to supply motive power to at least one wheel 14. As would be recognized by one of ordinary skill with vehicles, the engine assembly 18 of the ATV 10 also includes, inter alia, an electrical power source (not shown), a cooling system 22 (see FIG. 2) adapted to cool the engine 20, a fuel system (not shown) to provide fuel to the engine 20, and a carburetor 24 adapted to receive air from the environment and fuel from the fuel system to provide a fuel-air mixture to the engine 20.

FIG. 2 is an exploded view of a portion of the engine assembly 18, used in the ATV 10, according to one embodiment of the present invention. The cooling system 22 is adapted to circulate coolant through the engine 20 from a radiator 26. Coolant is supplied to the radiator 26 from a coolant supply 28, as is known. The coolant flow path includes an outlet coolant line 30 extending from the radiator 26 to a coolant pump 31 of the engine 20, which circulates cooling fluid to the engine 20, and an inlet coolant line 32 extending from a thermostat 33 of the engine 20 back to the radiator 26 to return heated cooling fluid to the radiator 26. The direction of coolant flow is shown by the arrows in FIG. 2. Coolant lines 30, 32 are preferably formed of flexible hoses that are clamped to the radiator 26 by adjustable couplings 34 and to the engine 20 by adjustable couplings 36.

The carburetor 24 is connected to the engine 20, as is known, so that an air-fuel mixture is provided to the engine 20. A carburetor heater 40 is coupled to the carburetor 24, as described in detail below. The carburetor heater 40 is preferably disposed in the coolant flow path of the cooling system 22. The carburetor heater 40 is disposed in the coolant path to receive heated coolant and return cooled coolant to the engine 20.

A fitting 42 is disposed in the radiator inlet cooling line 32, by clamps 44, for example. Attached to the fitting 42 is an inlet heater hose 46. The attachment can be accomplished by any known fluid path attachment mechanism, such as a nipple 48 and clamp 50. The inlet heater hose 46 is secured to the carburetor heater 40 by an angle fitting 52 and tightening ring 54. By this, coolant leaving the engine 20 is delivered to the carburetor heater 40 through a secondary coolant flow path.

Coolant that has passed through the carburetor heater 40 is then delivered through an outlet heater hose 56 to the radiator outlet line 30. By this arrangement, coolant that has passed through the heater 40, and accordingly cooled, is provided to the engine 20. The outlet heater hose 56 is attached in a similar manner between the carburetor heater 40 and the outlet line 30 as the inlet heater hose 46. In particular, the outlet heater hose 56 is secured to the carburetor heater 40 by an angle fitting 58 and ring 60 and is secured to a fitting 62 clamped in line 30 by a nipple 64 and clamp 66. Preferably, the hoses 46 and 56 are formed of flexible material, which attenuates vibrations from the engine 20 to the carburetor heater 40. The hose 46 and, if desired the hose 56, may also be formed of heat insulating material. Of course, other known types of fittings and clamps may be used to form a liquid tight flow path, including integral fittings and hoses.

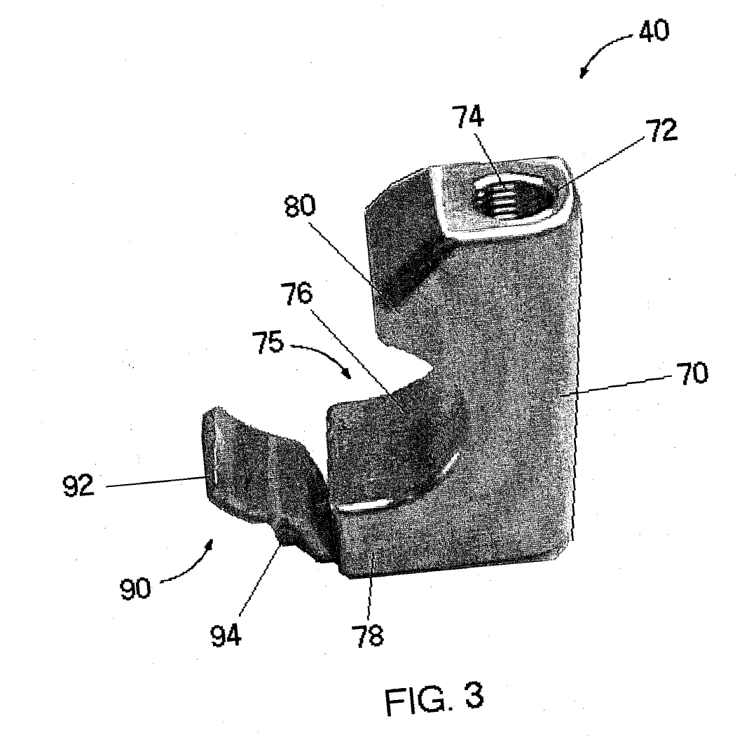

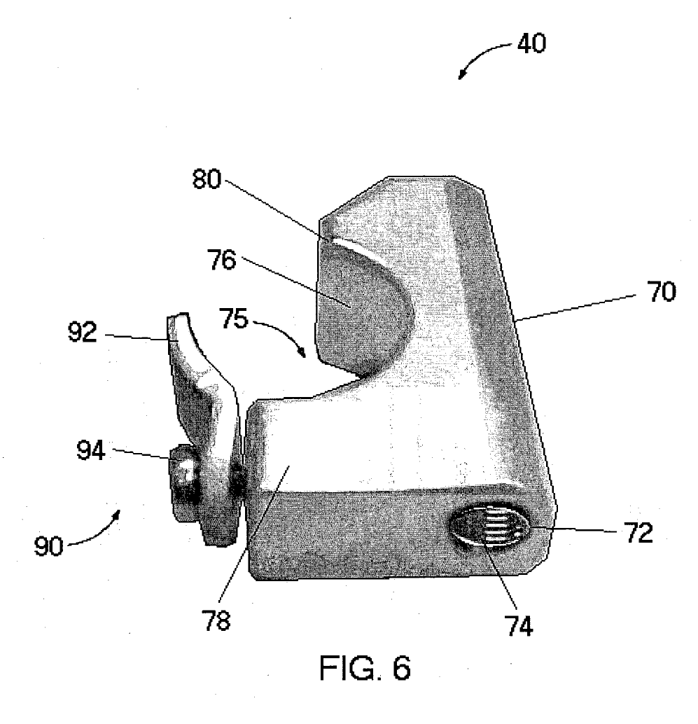

Now referring to FIGS. 3-6, the carburetor heater 40 is shown in detail. The carburetor heater 40 has a heat conducting body 70 that includes a through passage 72 designed to receive the flow of coolant from the hose 46. Each end of the through passage 72 preferably has attachment formations, in this case internal threads 74, to attach to the fittings 52 and 58, respectively, as seen in FIGS. 3 and 6. It is also contemplated that the fluid path could be formed as a heat conducting conduit that extends through the passage 72 in the body 70, thus eliminating the need for the fittings 52 and 58. The entire extent of the passage 72 can have a constant or varying cross-sectional diameter. For example, the passage 72 can form a substantial portion of the interior of the body 70. Additionally, the passage 72 can take a varying path through the body 70 of the carburetor heater 40. For example, the passage 72 can take a sinusoidal or circuitous path. The path and/or shape of the passage 72 can be chosen to achieve a predetermined heat transfer rate from the coolant to the carburetor heater 40, and/or to achieve a predetermined flow characteristic and/or flow impedance.

The body 70 is preferably formed of a heat conducting material, such as metal. For example, the body 70 can be constructed from cast aluminum, preferably 6061T6 aluminum. In addition to providing good heat conduction, aluminum provides high strength and lightweight construction. As would be appreciated by those skilled in the art, other materials could also be used, such as titanium or steel.

The exterior shape of the body 70 of the carburetor heater 40 is shaped to adapt to the exterior surface of the carburetor 24. In particular, the exterior shape of the body 70 is designed to complement the mixing chamber of the carburetor 24, especially the vertical portion of the mixing chamber in which the piston slides and the air and fuel are mixed. The body 70 is also designed to complement the air intake duct.

As illustrated in FIGS. 3 and 6, the body 70 includes a first depression 75, in the form of a curved surface 76, with a radius of curvature which is shaped to correspond to a first surface of the carburetor 24. The first curved surface 76 is defined by a first lobe 78 and a second lobe 80 extending outwardly from the body 70 of the carburetor heater 40. The first depression 75 is formed generally about an axis that is perpendicular to the coolant passage 72.

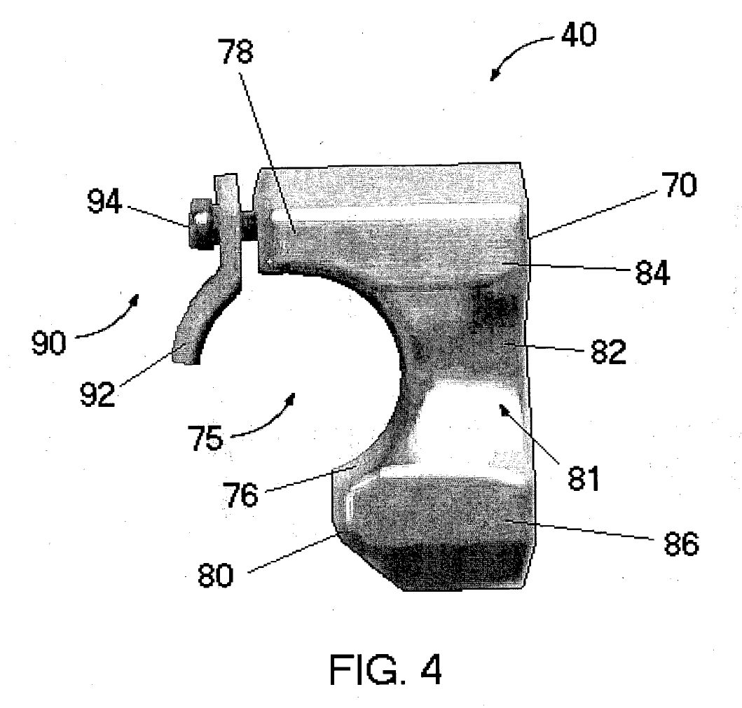

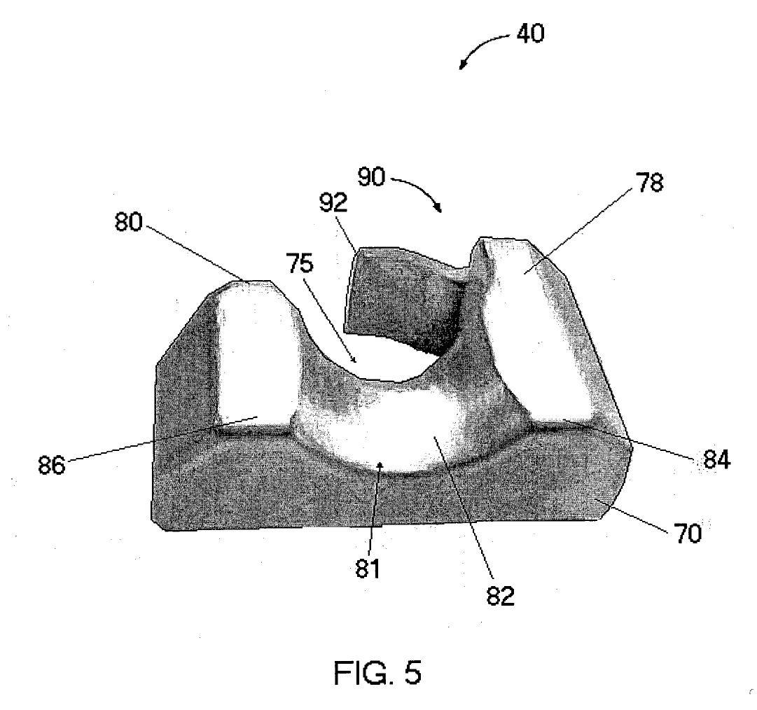

FIGS. 4 and 5 show another surface of the carburetor heater 40 from a bottom view, taken along the plane formed by the radius of curvature of the first curved surface 76. A second depression 81, formed as a curved surface 82, is visible from this viewpoint. The second curved surface 82 has a radius of curvature perpendicular to the radius of curvature of the first curved surface 76 and is also formed generally about an axis that is perpendicular to the coolant passage 72. The second depression 81 corresponds to a second surface of the carburetor 24 to which the body 70 of the carburetor heater 40 is adapted. The second curved surface 82 is formed by a third lobe 84 and a fourth lobe 86, which extend from the body 70. The third and fourth lobes 84, 86 extend generally perpendicularly to the extension of the first and second lobes 78, 80.

It is contemplated that the arrangement of the first depression 75 and the second depression 81 may vary depending upon the exterior shape of the carburetor 24. For example, the radius of curvature of each of the depressions 75 and 81 may vary from one another. Alternatively, while the depressions 75, 81 are shown as semi-circular, they may be irregularly shaped. Also, if the exterior surface of the carburetor 24 is angular with box-like corners, the surface of the heater 40 may be shaped with polygonal depressions. Additionally, the depressions 75 and 81 may be arranged with respect to each other at angles other than 90 degrees. For example, non-perpendicular surfaces may accommodate corresponding surfaces of the carburetor 24 that are not arranged perpendicularly to each other.

The relationship between the planes formed by the depressions 75, 81, in this case the radii of curvature of the curved surfaces 76, 82, allows the carburetor heater 40 to come in close contact with two surfaces of the carburetor 24. Moreover, the first and second lobes (78 and 80) of the first depression 75 and the third and fourth lobes (84 and 86) of the second depression 81 allow a proportionately large surface area of the body 70 of the carburetor heater 40 to come in contact with the carburetor 24, especially the portion of the carburetor 24 in which mixing occurs.

A large surface area relative to the volume of the carburetor heater 40 in contact with the carburetor 24 can improve heating efficiency and can also reduce heat wasted (transferred to the environment) during operation of the carburetor heater 40. If the lobes 78, 80, 84 and 86 are hollow, incorporate a portion of the passage 72, and accommodate coolant within the body 70, the heating capacity of the carburetor heater 40 may be improved.

The relative shapes and dimensions of the carburetor heater 40 may be varied and remain within the scope of this invention. For example, various ones or all of the lobes 78, 80, 84, and 86 can extend farther from the body 70, thereby providing more heat transfer area, or can extend less to provide a-more compact carburetor heater 40. The amount of contact selected between the carburetor heater 40 and the exterior of the carburetor 24 may be based upon factors including the amount of heat transfer desired between the carburetor heater 40 and the carburetor 24.

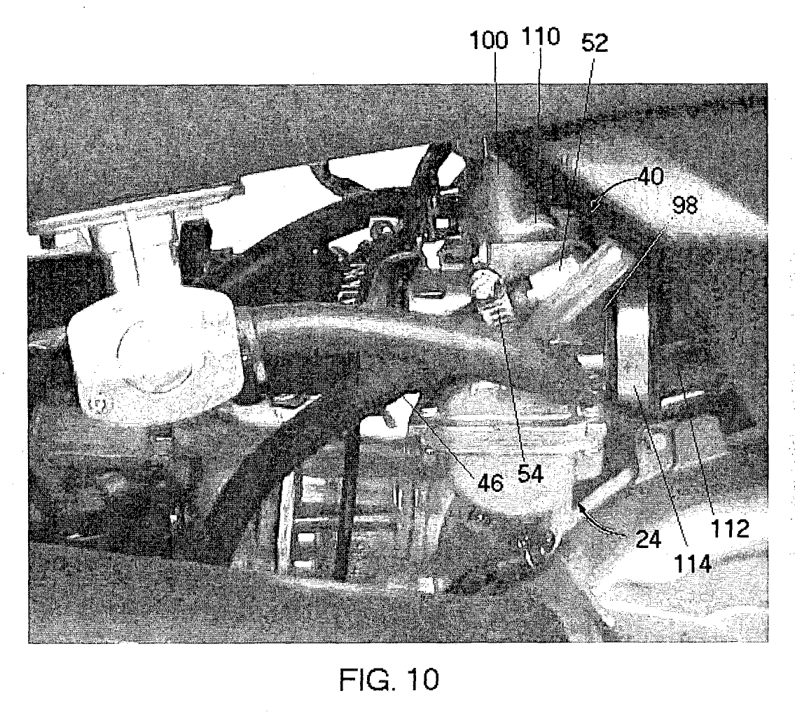

An interface material in the form of a thermal conductor 110 seen in FIG. 10, and described below, may also be used to accommodate the differences between the shapes of the carburetor heater 40 and corresponding exterior surface of the carburetor 24. The thermal conductor 110 may also enhance conduction of heat.

A fastener 90 is preferably attached to the body 70 for releasably fastening the carburetor heater 40 to an exterior surface of the carburetor 24. The fastener 90 may include a bracket 92 and a screw 94 that attaches to a threaded bore in the body 70. Of course, other suitable fasteners such as an adjustable clamp or tie may be utilized. The bracket 92 is shaped to complement the exterior surface of the carburetor 24.

As seen in FIG. 3, the fastener 90 is attached to an end of the first lobe 78 of the body 70. FIG. 4 illustrates a curved portion of the bracket 92. The curved portion of the bracket 92 shares the radius of curvature of the first curved surface 76. The bracket 92 cooperates with the first curved surface 76 to securely grip a cylindrical surface of the carburetor 24. The shape of the bracket 92 can depend on the corresponding exterior shape of the carburetor 24. The bracket 92 and the first curved surface 76 form an arc along the radius of curvature of the first curved surface 76, which sweeps an angle greater than 180 degrees. The shape of bracket 92 may correspond to the surface of the carburetor 24 with which it comes in contact and, accordingly, may have a shape or radius of curvature different from the radius of curvature of the first curved surface 76. Alternatively, the bracket 92 may have a non-curved shape such as a simple, flat, rectangle or oval, regardless of the shape of the corresponding surface of the carburetor 24, for simplicity of manufacture.

The bracket 92 is intended to securely clamp the heater 40 to the carburetor 24 as the fastener 90 is the primary attachment mechanism that holds the heater 40 to the carburetor 24. The bracket 92 may be a thin flexible material of sufficient strength and/or thickness to secure the carburetor heater 40 to the exterior surface of the carburetor 24. The bracket 92 may be made of metal, for example, which conducts heat and therefore will assist in the transfer of heat from the cooling fluid to the carburetor 24. The bracket 92 also may be flexible.

As illustrated, the fastener 90 is provided as a separate component from the body 70 of the carburetor heater 40. The screw 94, or other suitable component, removably attaches the bracket 90 to the :body 70. Alternatively, the fastener 90 can be constructed integrally with the body 70, and/or can be formed from a flexible extension of the body 70 to allow the carburetor heater 40 to be mounted to the carburetor 24 without requiring separate components for the fastener 90.

The fastener 90 is preferably small and easily attached to the carburetor. Further, the fastener 90 is designed to directly clamp the heater 40 to the carburetor 24, without contacting the engine 20 or the frame 12. This mounting arrangement isolates the heater 40 and the carburetor 24 from the majority of vibrations caused by the engine 20 and frame 12 of the ATV 10. Accordingly, a consistent fuel-air ratio can be provided and performance of the carburetor 24 can be enhanced.

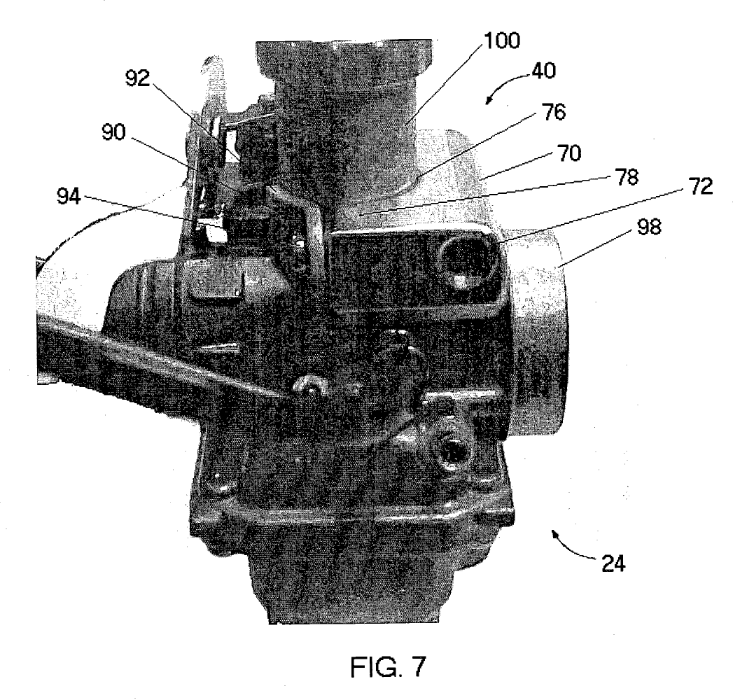

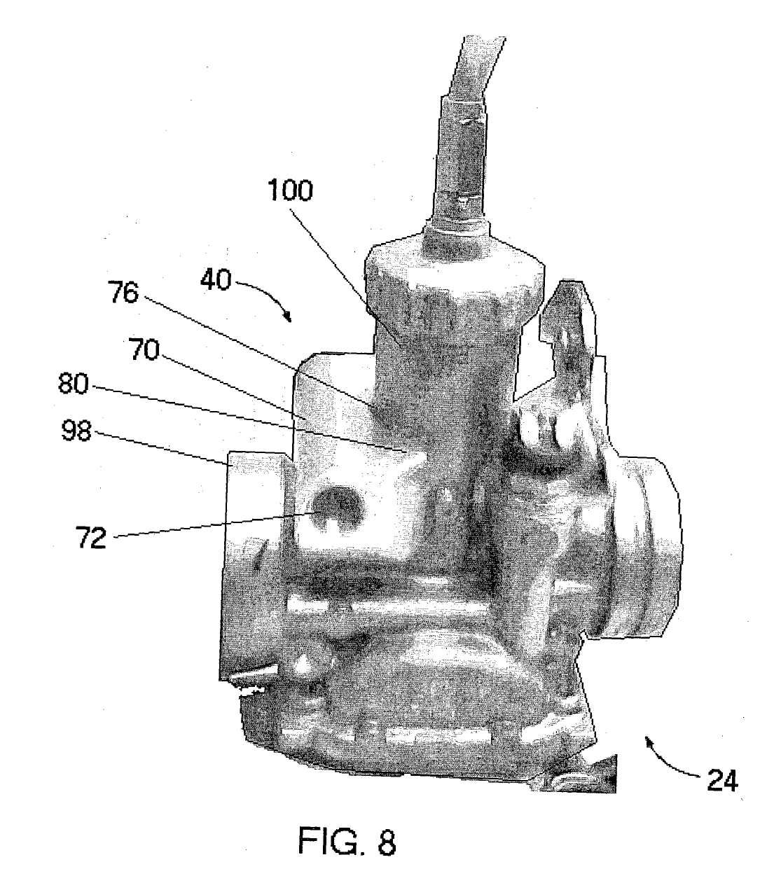

FIGS. 7-9 illustrate the carburetor heater 40 mounted to the carburetor 24 without showing the associated interconnections to the cooling system 20 illustrated in FIGS. 2 and 10. The carburetor heater 40 is shown secured to the exterior surface of the perpendicular intersection of the intake duct 98 and a vertical portion 100 of a mixing chamber of the carburetor 24. FIG. 7 also illustrates the bracket 92 and screw 94 securing the carburetor heater 40 to the carburetor 24. The bracket 92 contacts the vertical portion 100 of the exterior of the carburetor 24.

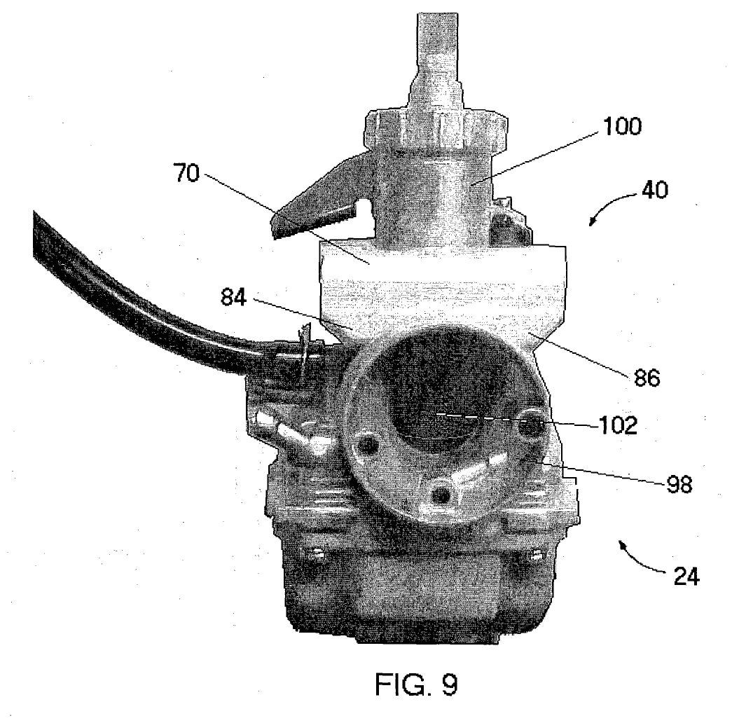

The carburetor heater 40 applies heat directly to the intake duct 98 and the vertical portion 100 of the carburetor 24, particularly to those portions that are susceptible to moisture freezing, including within the intake duct 98, along a valve piston 102 (seen in FIG. 9) and within the vertical portion 100 of the carburetor 24. By this, heat is applied directly to the portions of the exterior of the carburetor 24 where it is particularly beneficial, without wasting heat to the environment. This design allows surface area contact to be maximized between the carburetor heater 40 and relevant parts of the exterior of the carburetor 24.

FIG. 10 shows the carburetor heater 40 and the carburetor 24 of FIGS. 7-9 mounted within an ATV 10 along with the associated interconnections to the cooling system 22 of the engine assembly 18 illustrated in FIG. 2. In the illustrated embodiment, a thermal conductor 110 in the form of a paste is applied between the exterior surface of the carburetor 24 and corresponding surfaces of the carburetor heater 40. In addition to increasing the thermal conduction between the carburetor heater 40 and the carburetor 24, the thermal conductor 110 increases the friction between the carburetor heater 40 and the carburetor 24, thereby improving the stability of the mounted carburetor heater 40 with respect to the carburetor 24. Preferably, the thermal conductor 110 can also attenuate vibrations between the carburetor heater 40 and the carburetor 24. An exemplary thermal conductor 110 is Loctite 384, which provides a secure connection and good thermal conduction between the carburetor heater 40 and the carburetor 24. The thermal conductor 110 additionally may accommodate variations between the exterior surface of the carburetor 24 and the corresponding surfaces of the carburetor heater 40. For example, the thermal conductor 110 may establish sufficient surface area contact and thermal conduction between the exterior surface of the carburetor 24 and the carburetor heater 40 when the surfaces do not match in shape and/or size.

FIG. 10 illustrates a flexible intake port 112, secured to the carburetor 24 via an intake port clamp 114. The construction of the flexible intake port 112 serves to further attenuate vibrations associated with the carburetor 24. The compact size of the carburetor heater 40 allows the flexible intake port 112 to be mounted to the carburetor 24 via the intake clamp 114 without any modifications to accommodate the carburetor heater 40. Additionally, contact between the carburetor heater 40 and the intake port 112 is minimized or eliminated, preventing any rubbing or forcing away of the carburetor heater 40 from the carburetor 24 caused by shifting of the intake clamp 114 or the intake port 112.

FIG. 10 also illustrates the inlet line 46 from the coolant path of the engine assembly 18 and the interconnection between the carburetor heater 40 and the inlet line 46 at fitting 52.

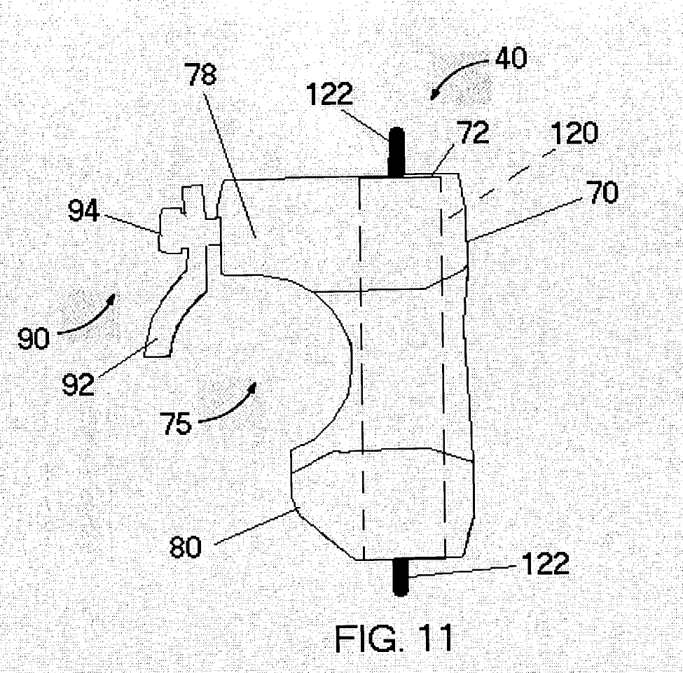

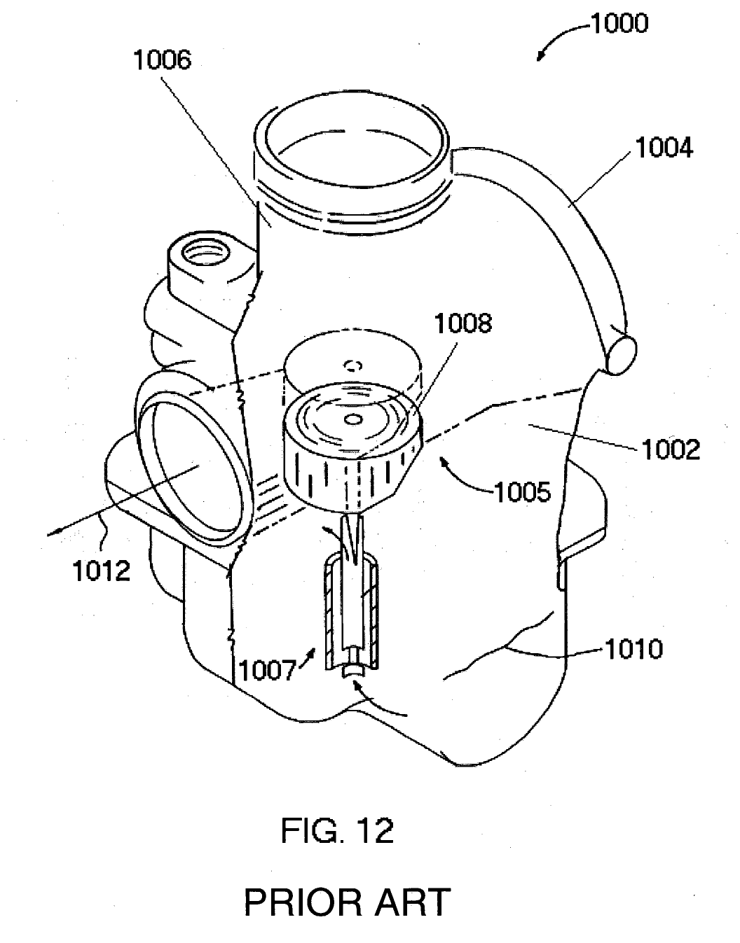

In another embodiment seen in FIG. 11, the carburetor heater 40 may include an electrical heating element 120 (shown schematically) arranged within the passage 72 to provide heat to the carburetor heater 40. Although the electrical heating element 120 may be used in conjunction with a flow of coolant from the cooling system 22 of the engine assembly 18, the carburetor heater 40 can be mounted to provide heat to the carburetor 24 without any coupling to the cooling system 22, if desired. Accordingly, in embodiments without any coupling to the cooling system 22, the various interconnections coupling the carburetor heater 40 to the cooling system 22 are not necessary.

Preferably, the electrical heating element 120 has good thermal contact with the inner surfaces of the passage 72. For example, a thermal conductor can be used to improve thermal communication between the electrical heating element 120 and the inner surfaces of the passage 72. The electrical heating element 120 may include electrical leads 122 for connection to an electrical system (not shown) of the ATV 10, allowing the carburetor heater 40 to be installed on an ATV 10 or other vehicle without a liquid cooling system 22. Electrical power may be applied selectively to the electrical heating element 120 independently of operation of the engine 20. Accordingly, it is possible to preheat the carburetor 24 prior to operation of the engine 20. Preheating is desirable in situations where freezing moisture in the carburetor 24 has made it difficult or impossible to start the engine 20.

The electrical heating element 120 may be a simple resistive heating element, for example. To conserve electrical power consumption by the electrical heating element 120, electrical power may be applied only during specific conditions. For example, electrical power may be applied according to ambient environmental temperature, according to temperature within the carburetor intake duct 98, according to engine temperature, or according to any combination of relevant temperatures. Additionally, electrical power may be applied according to humidity conditions and/or positions of the valve piston (i.e., throttle positions). Alternatively, the electrical heating element 120 may incorporate a positive temperature coefficient (PTC) thermistor. A PTC thermistor may vary the heat produced according to temperature. Accordingly, the PTC thermistor may vary the electrical power consumed by the electrical heating element 120. As the temperature of the PTC thermistor increases, heat production and electrical power consumption by the electrical heating element 120 decreases.

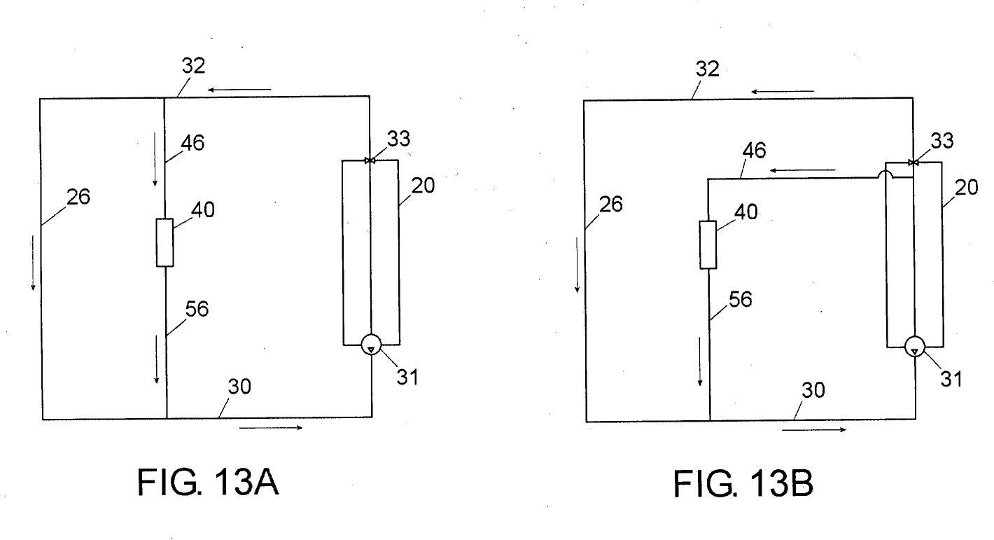

FIG. 13A shows the coolant flow path according to the engine assembly illustrated in FIG. 2. The coolant pump 31 pumps coolant through the engine 20 and the thermostat 33. The coolant passes through the thermostat 33 prior to circulating through the carburetor heater 40 and the radiator 26. Coolant flow via the secondary coolant flow path (including the inlet heater hose 46, the carburetor heater 40, and the outlet heater hose 56) is affected by operation of the thermostat 33.

FIG. 13B shows a coolant flow path according to another embodiment of an engine assembly. The coolant pump 31 pumps coolant through the engine 20, at which point the coolant may flow through a secondary coolant flow path (including the inlet heater hose 46, the carburetor heater 40, and the outlet heater hose 56) and the thermostat 33. The coolant may circulate through the secondary coolant flow path regardless of operation of the thermostat 33. In the arrangement shown in FIG. 13B, the coolant can circulate through the carburetor heater 40 despite the thermostat 33 operating in a closed position.

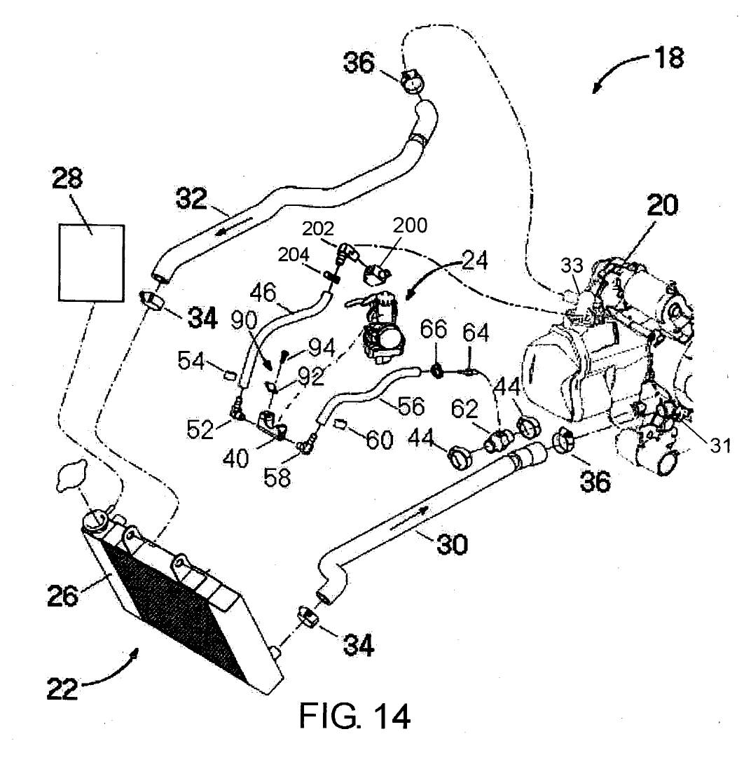

FIG. 14 is an exploded view of a portion of the engine assembly 18, used on the ATV 10, according to an embodiment of the present invention corresponding to the coolant flow path of FIG. 13B. In particular, the secondary coolant flow path (including the carburetor heater 40) shown in FIG. 14 may bypass the thermostat 33 partially or entirely.

The carburetor heater 40 is disposed in the secondary coolant flow path to receive heated coolant and return cooled coolant to the engine 20. A fitting 200 is disposed in the engine 20 upstream of the thermostat 33 in the coolant flow path. Attached to fitting 200 is an angle fitting 202. The attachment can be accomplished by any known fluid path attachment, such as a threaded attachment. The inlet heater hose 46 is secured to the angle fitting 202 by a tightening ring 204. By this, coolant leaving the engine 20 may bypass the thermostat 33 and may be delivered to the carburetor heater 40 through the secondary coolant flow path, regardless of whether the thermostat 33 is operating in an open or closed position.

Another embodiment of the carburetor heater 40 includes a self-contained heating medium provided separately from the cooling system 22 of the ATV 10. The heating medium is circulated through the passage 72 of the carburetor heater 40 via appropriate circulation means. The separate supply of the heating medium allows for the use of the carburetor heater 40 in an ATV 10 that is not equipped with a cooling system 22 (e.g., an ATV 10 with an air-cooled engine 20). The heating medium can be, for example, a compound which produces heat from chemical reactions. Alternatively, electrical power can be used to heat a fluid which is circulated through the passage 72 of the carburetor heater 40.

An additional benefit to the arrangement and structure of the carburetor heater 40 and associated hoses and fittings in accordance with the invention is that they may be retrofitted to an existing cooling system 22 of an ATV 10 with very minor modifications. The fittings 42 and 62 may be inserted at any point along the lines 30 and 32 of the cooling system 22 of the ATV 10. Preferably, the heater inlet fitting 42 is coupled to the outlet line 32 at a point close to the engine 20 so that the heat of the cooling fluid leaving the engine 20 is not dissipated.

The carburetor heater 40 can also easily be retrofitted to carburetors 24 with a variety of exterior shapes, especially to the illustrated carburetor 24 whose exterior shape is defined in part by two perpendicular intersecting cylinders. The relatively small size of the carburetor heater 40 allows for installation without interfering with the operation of the various components of the carburetor 40 or engine 20. No modifications of the carburetor 24 are necessary to accommodate the carburetor heater 40 prior to installation.

Additionally, because the carburetor heater 40 is directly mounted to the carburetor 24, there is no need for the use of external support to maintain contact between the surfaces of the carburetor heater 40 and the exterior of the carburetor 24. Accordingly, heat is effectively transferred directly to the exterior surface of the carburetor 24, particularly to the portions in need of protection from moisture freezing. The relatively small size and simple construction of the carburetor heater 40, without external support from the engine assembly 18 or the frame 12, preserves the isolation of the carburetor 24 from vibrations generated by the engine assembly 18 and the frame 12 while minimizing overall weight.

While the carburetor heater 40 has been described in conjunction with an ATV 10, as noted above, it is understood that the carburetor heater 40 can be used in conjunction with a variety of different carburetors, in vehicles including snowmobiles, personal watercraft, outboard engines, boats, and motorcycles for example. The carburetor heater 40 is particularly well suited to vehicles designed to operate in cold and/or humid environments.

The foregoing specific embodiments have been provided to illustrate principles of the present invention and are not intended to be limiting. To the contrary, the present invention is intended to encompass all modification, alterations, and substitutions within the spirit and scope consistent with the principles and novel features disclosed in any fashion herein.

What is claimed is:

1. An all-terrain vehicle comprising:
a frame;
a plurality of wheels rotatably mounted to the frame;
an engine assembly mounted to the frame, the engine assembly including a fuel system;
a carburetor operatively connected to the fuel system, the carburetor having a housing with an exterior surface, a fuel inlet, an air intake, and a mixing chamber; and
a carburetor heater adapted for use with the carburetor, the carburetor heater comprising a main body with a heating element and a fastener adapted to secure the carburetor heater to the exterior surface of the carburetor, the main body having at least a first shaped surface that complements and mates with a portion of the exterior surface of the carburetor.

2. The all-terrain vehicle of claim 1, wherein the main body has a second shaped surface that complements and mates with another portion of the exterior surface of the carburetor.

3. The all-terrain vehicle of claim 2, wherein the first shaped surface and the second shaped surface are curved.

4. The all-terrain vehicle of claim 3, wherein the first shaped surface and the second shaped surface are concave.

5. The all terrain vehicle of claim 4, wherein the first shaped surface and the second shaped surface abut at an angle to each other.

6. The all-terrain vehicle of claim 2, wherein the second shaped surface is formed as a groove in the main body.

7. The all-terrain vehicle of claim 1, wherein the main body has a first lobe and a second lobe and the first curved surface is formed between the first lobe and the second lobe.

8. The all-terrain vehicle of claim 7, wherein the first curved surface extends partially onto the first and second lobes.

9. The all-terrain vehicle of claim 7, wherein the main body has a second shaped surface, disposed at an angle to the first shaped surface, and formed between third and fourth lobes on the main body.

10. The all-terrain vehicle of claim 7, wherein the fastener extends from one of the first and second lobes.

11. The all-terrain vehicle of claim 10, wherein the first lobe extends from the main body at a greater distance than the second lobe, and the fastener is mounted to the first lobe.

12. The all-terrain vehicle of claim 1, further comprising a thermal conductor disposed between the carburetor heater and the exterior surface of the carburetor.

13. The all-terrain vehicle of claim 1, wherein the engine assembly further comprises a cooling system including a pathway and an engine cooling fluid carried in the pathway, wherein the carburetor heater forms a portion of the pathway of the cooling system, and the heating element includes the engine cooling fluid.

14. The all-terrain vehicle of claim 13, wherein the main body of the carburetor heater has a passage through which the engine cooling fluid passes.

15. The all-terrain vehicle of claim 13, wherein the engine assembly includes a cylinder block and the pathway is positioned so that the engine cooling fluid absorbs heat from the cylinder block and transfers the heat to the carburetor heater positioned downstream of the cylinder block.

16. The all-terrain vehicle of claim 13, further comprising a thermostat disposed in the pathway.

17. The all-terrain vehicle of claim 16, wherein the carburetor heater is downstream of the thermostat.

18. The all-terrain vehicle of claim 16, wherein the carburetor heater is upstream of the thermostat.

19. The all-terrain vehicle of claim 18, wherein the portion of the pathway formed by the carburetor heater bypasses the portion of the pathway formed by the thermostat.

20. The all-terrain vehicle of claim 1, further comprising an electrical system operatively connected to an electrical heating element disposed within the carburetor heater.

21. The all-terrain vehicle of claim 20, wherein the electrical heating element is a resistive heating element.

22. The all-terrain vehicle of claim 20, wherein the electrical heating element is a positive temperature coefficient thermistor.

23. The all-terrain vehicle of claim 1, wherein the fastener is an adjustable clamp.

24. The all-terrain vehicle of claim 23, wherein the adjustable clamp has a shaped surface that complements the first shaped surface of the carburetor heater so that a portion of the carburetor may be clamped therebetween.

25. The all-terrain vehicle of claim 1, wherein the first shaped surface abuts the exterior surface of the housing adjacent to the mixing chamber.

26. The all-terrain vehicle of claim 25, wherein the main body of the carburetor heater includes a second shaped surface that abuts the exterior surface of the housing adjacent to the air intake.

27. A carburetor heater for use with a carburetor, the carburetor heater comprising:
a main body;
a heating element disposed within the main body;
a shaped mounting surface formed in the main body; and
a fastener mounted to the main body and adapted to attach the main body to the carburetor so that the mounting surface mates with a surface of the carburetor.

28. The carburetor heater of claim 27, wherein the shaped mounting surface is an arcuate, concave surface.

29. The carburetor heater of claim 27, wherein the shaped mounting surface is formed by portions of the main body and a first lobe and a second lobe extending from the main body.

30. The carburetor heater of claim 29, wherein the fastener is mounted to the first lobe.

31. The carburetor heater of claim 27, further comprising a second shaped surface formed in the main body that is disposed at an angle to the shaped mounting surface.

32. The carburetor heater of claim 31, wherein the second shaped surface is a concave groove formed in the main body.

33. The carburetor heater of claim 27, wherein the shaped mounting surface has a first shaped surface formed by first curved surfaces of portions of the main body and first and second lobes extending from the main body, and wherein the main body has a second shaped surface formed by second curved surfaces of portions of the main body and third and fourth lobes extending from the main body, and the second shaped surface is disposed at an angle to the first shaped surface.

34. The carburetor heater of claim 27, wherein the main body is formed of heat conductive material.

35. The carburetor heater of claim 27, further comprising a thermal conductor disposed on the shaped mounting surface for enhancing thermal conduction between the carburetor heater and the carburetor.

36. The carburetor heater of claim 27, wherein the heating element includes a fluid passage passing through the main body.

37. The carburetor heater of claim 27, wherein the heating element includes an electrical heating element connected to the main body.

38. The carburetor heater of claim 37, wherein the electrical heating element is a resistive heating element.

39. The carburetor heater of claim 37, wherein the electrical heating element is a positive temperature coefficient thermistor.

40. The carburetor heater of claim 27, wherein the fastener is an adjustable clamp.

41. An internal combustion engine assembly comprising:
a fuel system;
a carburetor formed by a housing with a mixing chamber and an exterior surface, a fuel inlet and an air intake, and a carburetor heater for use with the carburetor, wherein the carburetor heater comprises
a main body,
a heating element disposed within the main body, and
a fastener mounted to the main body and adapted to secure the carburetor heater to the exterior surface of the carburetor, wherein the main body has at least a first shaped surface that complements and mates with a portion of the exterior surface of the carburetor.
